(19) United States
(12) Patent Application Publication
(10) Pub. No.: US 2003/0028452 A1
(43) Pub. Date: Feb. 6, 2003

(54) System, method and apparatus for formatting inventory data

(76) Inventor: James Pliny Whitney III, Seabrook, TX (US)

Correspondence Address: Daniel J. Chalker, GARDERE WYNNE SEWELL LLP, Suite 3000, 1601 Elm Street, Dallas, TX, 75201-4761, US

(21) Appl. No.: 09/923,926

(22) Filed: Aug. 6, 2001

(51) Int. Cl. G06F 17/60

(52) U.S. Cl. 705/28

(57) ABSTRACT

The present invention provides a system, method and apparatus for formatting inventory data wherein a request for inventory data about an inventory at a location is received and the inventory data is retrieved. The inventory data is formatted to be displayed in a calendar section, an inventory information section and a reservation information section within a single screen. A response containing the formatted inventory data is sent. Thereafter, one or more parameters further defining the request for inventory data may be received. For each received parameter it is determined whether the received parameter changes the formatted inventory data. If the received parameter changes the formatted inventory data, the inventory data changed by the received parameter is reformatted within the single screen and the reformatted inventory data is sent.

### TECHNICAL FIELD OF THE INVENTION

The present invention relates generally to the field of data processing and, more particularly, to a system, method and apparatus for formatting inventory data.

### BACKGROUND OF THE INVENTION

More and more consumers are turning to the Internet to plan, schedule and purchase travel, vacation and entertainment on their own. As a result, many hotels, airlines, rental car agencies, cruise lines and entertainment venues have established web sites either on their own or through third parties that allow consumers to view, select and purchase/reserve the provider's inventory on their own. These web sites are generally difficult and confusing to use because of the multitude of screens that must be successfully navigated. This is both frustrating and time consuming for potential customers. Accordingly, there is a need for system, method and apparatus for formatting inventory data within a single screen.

### SUMMARY OF THE INVENTION

The present invention provides a system, method and apparatus for formatting inventory data within a single screen. As a result, the present invention is easier and faster to use. Moreover, the use of a single screen to graphically display calendar information, inventory information and reservation information allows potential customers to vary their purchasing parameters at will and view the results immediately. Using a single screen to present the information allows the potential customer to experiment and view a greater number of inventory possibilities than before. The present invention is applicable to hotels, rental agencies, both vehicles and equipment, airlines, bus lines, railroads, cruise lines and entertainment venues, such as sporting events, concerts, plays, etc.

The present invention provides a method of formatting inventory data wherein a request for inventory data about an inventory at a location is received and the inventory data is retrieved. The inventory data is formatted to be displayed in a calendar section, an inventory information section and a reservation information section within a single screen. A response containing the formatted inventory data is sent. Thereafter, one or more parameters further defining the request for inventory data may be received. For each received parameter it is determined whether the received parameter changes the formatted inventory data. If the received parameter changes the formatted inventory data, the inventory data changed by the received parameter is reformatted within the single screen and the reformatted inventory data is sent.

In addition, the present invention provides a computer program embodied on a computer readable medium for formatting inventory data. The computer program includes a code segment for receiving a request for inventory data about an inventory at a location, a code segment for retrieving the inventory data and a code segment for formatting the inventory data to be displayed in a calendar section, an inventory information section and a reservation information section within a single screen. In addition, the computer program includes a code segment for sending a response containing the formatted inventory data and a code segment for receiving a parameter further defining the request for inventory data. A code segment for determining whether the received parameter changes the formatted inventory data is also included. Whenever the received parameter changes the formatted inventory data, a code segment is provided to reformat the inventory data changed by the received parameter within the single screen, and send the reformatted inventory data.

The present invention also provides a system for formatting inventory data that includes a database, a communications interface, and a computer communicably coupled to the database and the communications interface. The computer receives a request for inventory data about an inventory at a location from the communications interface, retrieves the inventory data from the database, formats the inventory data to be displayed in a calendar section, an inventory information section and a reservation information section within a single screen, sends a response containing the formatted inventory data to the communications interface, receives a parameter further defining the request for inventory data from the communications interface, and determines whether the received parameter changes the formatted inventory data, and reformats the inventory data changed by the received parameter within the single screen and sends the reformatted inventory data to the communications interface whenever the received parameter changes the formatted inventory data.

Other features and advantages of the present invention shall be apparent to those of ordinary skill in the art upon reference to the following detailed description taken in conjunction with the accompanying drawings.

### BRIEF DESCRIPTION OF THE DRAWINGS

For a better understanding of the invention, and to show by way of example how the same may be carried into effect, reference is now made to the detailed description of the invention along with the accompanying figures in which corresponding numerals in the different figures refer to corresponding parts and in which:

FIG. 1 is a block diagram of a network system in accordance with the present invention;

FIG. 2 is a flow chart of a method for formatting inventory in accordance with the present invention;

FIG. 3 is a general representation of a single screen format in accordance with the present invention;

FIGS. 4A and 4B are flowcharts of a method for selecting an inventory at a location in accordance with one embodiment of the present invention;

FIGS. 5A, 5B, 5C and 5D are flowcharts of a method for formatting the inventory data in accordance with one embodiment of the present invention;

FIG. 6 is a screen shot of the oneScreen interface prior to any user inputs in accordance with one embodiment of the present invention;

FIG. 7 is a screen shot of the oneScreen interface with one date only selected and no room type selected in accordance with one embodiment of the present invention;

FIG. 8 is a screen shot of the oneScreen interface with multiple dates selected and no room type selected in accordance with one embodiment of the present invention;

FIG. 9 is a screen shot of the oneScreen interface with multiple dates selected, room type selected and selected dates showing daily rates in accordance with one embodiment of the present invention;

FIG. 10 is a screen shot of the oneScreen interface as in FIG. 9, but more dates added to include a check-out-only date in accordance with one embodiment of the present invention;

FIG. 11 is a screen shot of the oneScreen interface wherein another room type and different dates are selected, and an extra room is added in accordance with one embodiment of the present invention;

FIG. 12 is a screen shot of the oneScreen interface as in FIG. 11, but extra rooms and people are added in accordance with one embodiment of the present invention;

FIG. 13 is a screen shot of the oneScreen interface showing a pop-up error/status message that prevents clicking on the Finish Reservation button until all required tasks are complete in accordance with one embodiment of the present invention;

FIG. 14 is a screen shot of the oneScreen interface wherein the form is almost filled out, Finish Reservation button not yet clickable in accordance with one embodiment of the present invention;

FIG. 15 is a screen shot of the oneScreen interface wherein all information has been entered into the form and the Finish Reservation button turns on in accordance with one embodiment of the present invention;

FIG. 16 is a screen shot of the oneScreen interface wherein the reservation and personal information are being sent, and the user is waiting for confirmation from the server in accordance with one embodiment of the present invention;

FIG. 17 is a screen shot of the oneScreen interface showing the confirmation screen after the reservation has been inserted into the database and retrieved a confirmation number in accordance with one embodiment of the present invention;

FIG. 18 is a screen shot of the oneScreen interface showing the Broadmoor loading sequence in accordance with one embodiment of the present invention;

FIG. 19 is a screen shot of the oneScreen interface showing the Pinehurst version loading sequence in accordance with one embodiment of the present invention;

FIG. 20 is a screen shot of the oneScreen interface of the Pinehurst version main operating space with no user inputs in accordance with one embodiment of the present invention;

FIG. 21 is a screen shot of the oneScreen interface Pinehurst version with dates and room type selected in accordance with one embodiment of the present invention;

FIG. 22 is a screen shot of the oneScreen interface Pinehurst version, showing pop-up Virtual Tour window in accordance with one embodiment of the present invention;

FIG. 23 is a screen shot of the oneScreen interface HTML version before any user inputs in accordance with one embodiment of the present invention;

FIG. 24 is a screen shot of the oneScreen interface wherein clicking calendar date shows availability on the room type frame in accordance with one embodiment of the present invention;

FIG. 25 is a screen shot of the oneScreen interface wherein room type availability is displayed, selecting a room type shows availability on calendar in accordance with one embodiment of the present invention; and

FIG. 26 is a screen shot of the oneScreen interface HTML version showing another room type selected, room type availability and calendar availability in accordance with one embodiment of the present invention.

### DETAILED DESCRIPTION OF THE INVENTION

While the making and using of various embodiments of the present invention are discussed in detail below, it should be appreciated that the present invention provides many applicable inventive concepts, which can be embodied in a wide variety of specific contexts. For example, in addition to travel and entertainment applications, the present invention may be applicable to other forms of business that manage, sell and reserve inventory over specified time periods. The specific embodiments discussed herein are merely illustrative of specific ways to make and use the invention and do not limit the scope of the invention.

The present invention provides a system, method and apparatus for formatting inventory data within a single screen. As a result, the present invention is easier and faster to use. Moreover, the use of a single screen to graphically display calendar information, inventory information and reservation information allows potential customers to vary their purchasing parameters at will and view the results immediately. Using a single screen to present the information allows the potential customer to experiment and view a greater number of inventory possibilities than before. The present invention is applicable to hotels, rental agencies, both vehicles and equipment, airlines, bus lines, railroads, cruise lines and entertainment venues, such as sporting events, concerts, plays, etc.

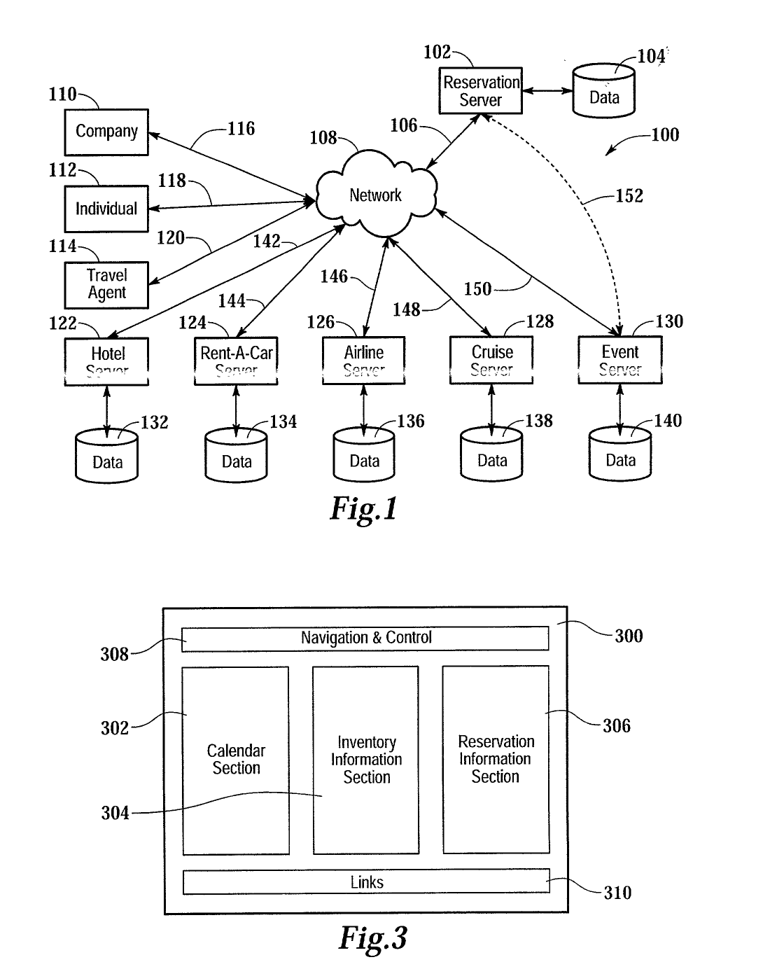

FIG. 1 is a block diagram of a network system 100 in accordance with the present invention. The system includes a reservation server 102 communicably coupled to a database 104. The reservation server 102 is typically communicably coupled to a network 108, such as the Internet via communication link 106. Customers, such as companies 110, individuals 112 and travel agents 114 can access the reservation server 102 via communication link 106, network 108 and communication links 116, 118 and 120 respectively. The reservation server 102 can be operated by an inventory owner or a third-party reservation service. Inventory owners may include hotels 122, rental agencies (vehicles and equipment) 124, airlines 126, bus lines (not shown), railroads (not shown), cruise lines 128 and entertainment venues (events) 130. Each inventory owner 122, 124, 126, 128 and 130 will operate a server communicably coupled to a database 132, 134, 136, 138 and 140 respectively. The reservation server 102 periodically accesses the inventory owners databases 132, 134, 136, 138 and 140 via communication link 106, network 108 and communication links 142, 144, 146, 148 and 150, respectively, to obtain inventory data and store that data in database 104. Alternatively, the inventory owners databases, such as 140, can be accessed via a direct communication link 152, such as a telephone line or satellite link.

The database 104 may include various tables, such as a reservations table, a guest table, a room table, a rate table and a room inventory table, etc. The reservations table may include the following variables: Confirmation ID, Hotel ID, Guest ID, Date In, Date Out, Number of Days, Number of Rooms, Room Type, Rate Type, Number of Adults, Number of Children, Credit Card Holder, Credit Card Type, Credit Card Number, Credit Card Expiration Date, Notes, Last Update, Entry Date, Amount, Rate List, and Taxes. The guest table may include the following variables: E-mail Address, Last Name, First Name, Address, City, State, Country, Zip Code, Daytime Phone Number, Fax Number, Last Update. The room type table may include may include the following variables: Room ID, Room Code, Hotel ID, Room Type, Room Description, Full Room Description, Room Base Price, Room Max Price, Price Per Room, Sort Order, Room Description in French, Room Description in Portuguese, Room Description in French. The rate table may include the following variables: Rate ID, Hotel ID, Room Type, Rate Type, Minimum Stay, Rate per Room, Date From, Date To, Rate Amount, Rate Amount W, Entry Date, Last Update, and Users. The room inventory table may include the following variables: Room ID, Hotel ID, Room Type, Room Description, Date From, Date To, Room #1, Room #2, Room #3, Room #4, Room #5, Room #6, Room #7, Last Update and Users.

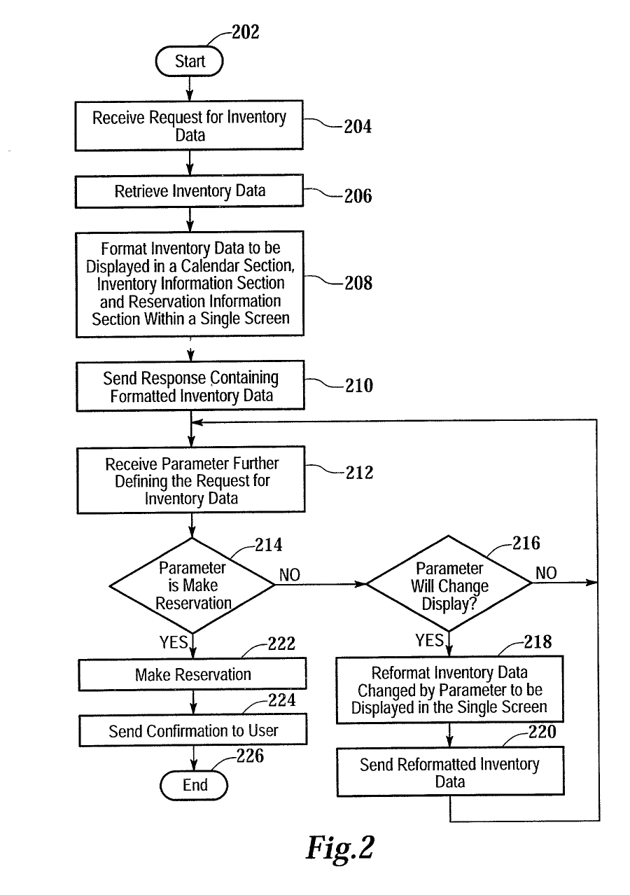

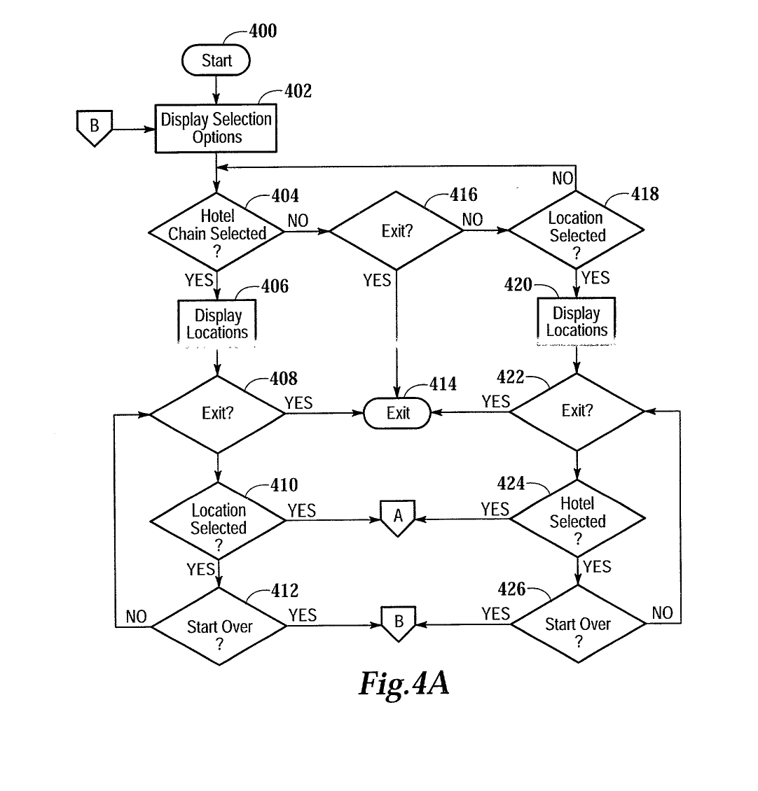

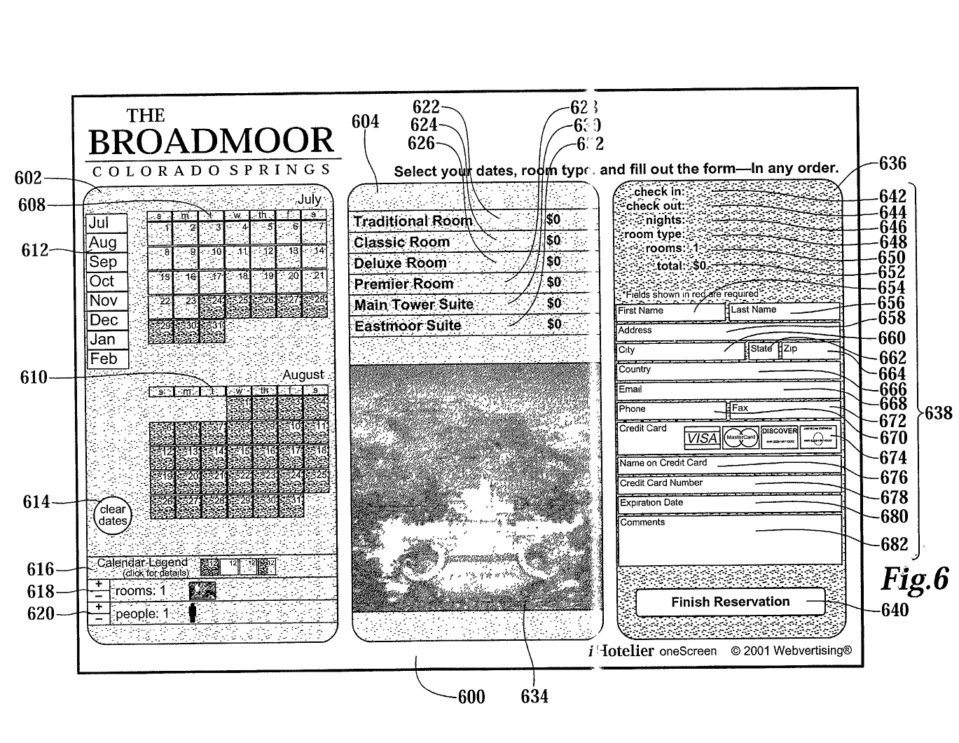

Now referring to FIG. 2, a flow chart of a method for formatting inventory 200 in accordance with the present invention is shown. The process starts in block 202 when the reservation server 102 (FIG. 1) receives a request for inventory data in block 204. Examples of typical inventory data for a hotel application are illustrated in FIGS. 6 through 26. The reservation server 102 (FIG. 1) retrieves the inventory data from database 104 (FIG. 1) in block 206, and formats the inventory data to be displayed in a calendar section 302 (FIG. 3), inventory information section 304 (FIG. 3) and reservation information section 306 (FIG. 3) within a single screen (referred to as a oneScreen) 300 (FIG. 3) in block 208. The reservation server 102 (FIG. 1) sends a response containing the formatted inventory data to the requesting user in block 210. As illustrated below, the formatted inventory data may be implemented using FLASH, a HTML format or other graphical user interface format. The user may click on various aspects of the oneScreen 300 (FIG. 3) to change and submit various inventory parameters, which further define the request for inventory data and is received by the reservation server 102 (FIG. 1) in block 212. If the received parameter is not an instruction to make a reservation, as determined in decision block 204, and the received parameter will not change the display, as determined in decision block 216, the process waits to receive another parameter in block 212 and the process repeats. If, however, the received parameter will change the display, as determined in decision block 216, the reservation server 102 (FIG. 1) will reformat the inventory data changed by the received parameter to be displayed in the single screen in block 218. The reservation server 102 (FIG. 1) sends the reformatted inventory data to the user in block 220, and the process waits to receive another parameter in block 212 and the process repeats. If, however, the received parameter is an instruction to make a reservation, as determined in decision block 204, the reservation server 102 (FIG. 1) makes the reservation in block 222, sends a confirmation to the user in block 224 and ends in block 226. The typical methods for making the reservation are known by those skilled in the art.

FIG. 3 is a general representation of a single screen format 300 in accordance with the present invention. The single screen format (oneScreen) 300 may display the inventory data in a calendar section 302, a inventory information section 304 and a reservation information section 306. The calendar section 302 may include one or more calendars, such as a first calendar for a current month, a second calendar for a next month and a month selection portion. The calendar section 302 may also be configured to display twelve monthly calendars, which can be scaled or zoomed in or out using the user's mouse. The inventory information section 304 may include one or more types of the inventory and an indication of availability for each type of the inventory. The reservation information section 306 may include one or more customer data fields, one or more payment data fields and an order summary. The single screen format (oneScreen) 300 may also include one or more links to other information 308 and one or more navigation and control commands 310. Other configurations are possible and within the scope of the present invention.

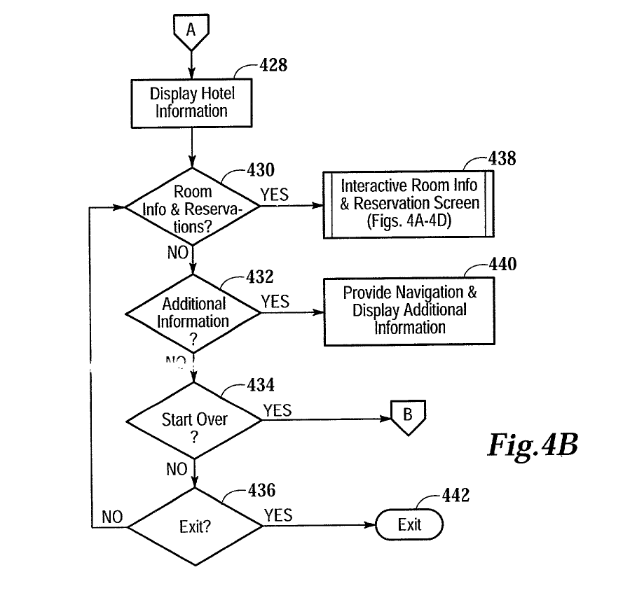

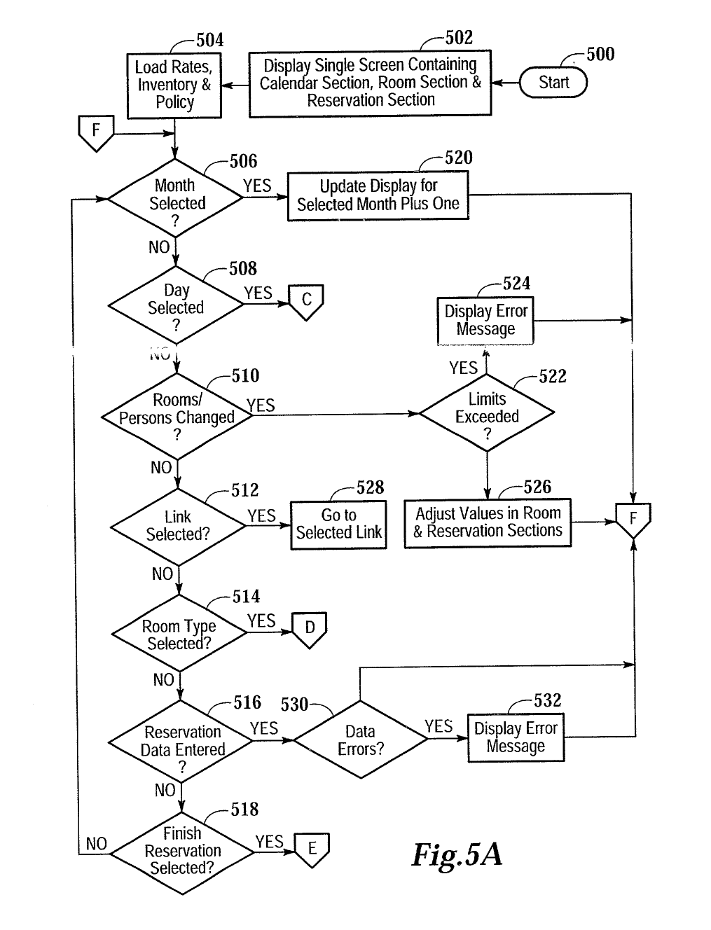

Now referring to FIGS. 4A and 4B, flowcharts of a method for selecting an inventory at a location in accordance with one embodiment of the present invention are shown. The process starts in block 400 and display selection options, such as selecting a hotel chain, selecting a geographic location, or exiting the process are presented to the user in block 402. If the user selects a hotel chain as determined in decision block 404, a list of locations for that hotel chain is displayed in block 406. The user may exit (decision block 406), select a location (decision block 408) or start over (decision block 410). The process will loop until one of these options is selected. If the user selects exit, as determined in decision block 408, the process ends in block 414. If the user selects a location, as determined in decision block 410, the hotel information and reservation process (FIG. 4B) is executed. If the user selects start over, as determined in decision block 412, the process loops back to block 402 where the selection options are displayed.

If the user did not select a hotel chain, as determined in decision block 404, the user may select exit (decision block 416) or select a location (decision block 418). If the user selects exit, as determined in decision block 416, the process ends in block 414. If the user selects a location as determined in decision block 418, a list of hotels at the selected location is displayed in block 420. The user may exit (decision block 422), select a hotel (decision block 424) or start over (decision block 426). The process will loop until one of these options is selected. If the user selects exit, as determined in decision block 422, the process ends in block 414. If the user selects a hotel, as determined in decision block 424, the hotel information and reservation process (FIG. 4B) is executed. If the user selects start over, as determined in decision block 426, the process loops back to block 402 where the selection options are displayed.

If the user has selected both a hotel and a location, the hotel information and reservation process (FIG. 4B) is executed by displaying the hotel information for that location in block 428. The user may then select room information and reservations (decision block 430), additional information (decision block 432), start over (decision block 434) or exit (decision block 436). The process will loop until one of these options is selected. If the user selects room information and reservations, as determined in decision block 430, the interactive room information and reservation screen (onscreen 300, FIG. 3) is activated in block 438 (See FIGS. 4A through 4D). If, however, additional information is selected, as determined in decision block 432, navigation information and additional information are displayed in block 440. If, however, the user selects start over, as determined in decision block 434, the process loops back to block 402 where the selection options are displayed. If, however, the user selects exit, as determined in decision block 436, the process ends in block 442.

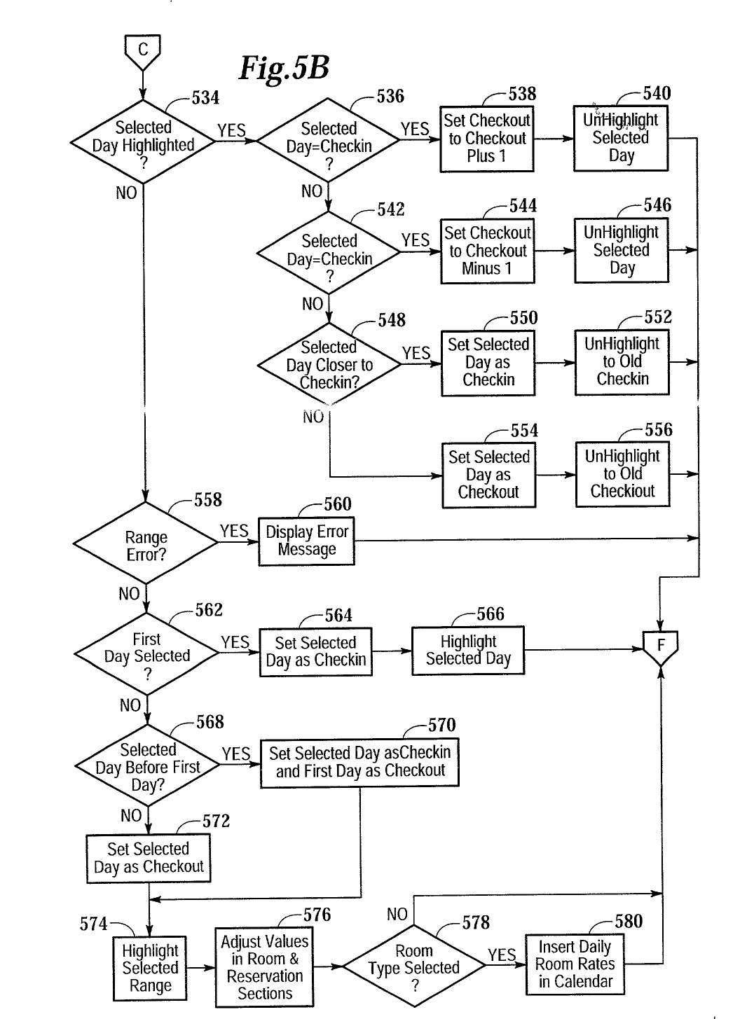

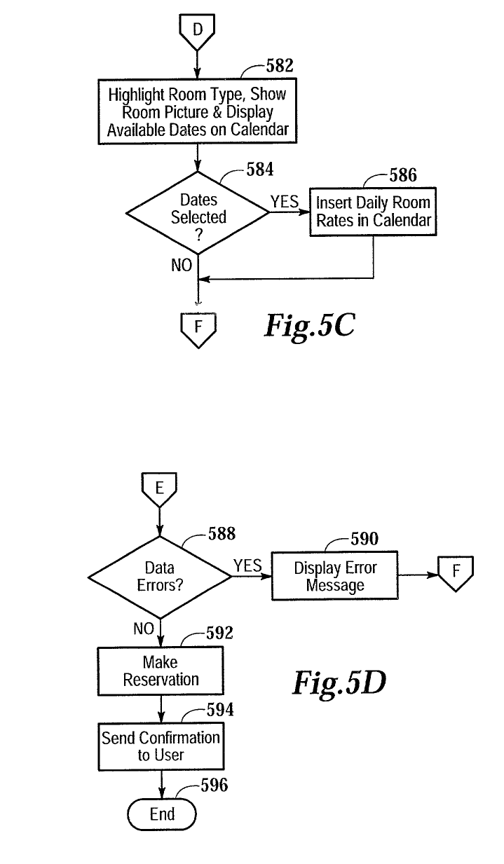

Referring now to FIGS. 5A, 5B, 5C and 5D, flowcharts of a method for formatting the inventory data (FIG. 4B, block 438) in accordance with one embodiment of the present invention are shown. The process starts in block 500 and a single screen (oneScreen) 300 (FIG. 3) containing a calendar section 302 (FIG. 3), a room section 304 (FIG. 3) and a reservation section 306 (FIG. 3) are displayed in block 502. Room rates, inventory and policies are loaded in block 504. The user can then click on various portions of the single screen (oneScreen) 300 (FIG. 3) to select a month (decision block 506), select a day (decision block 508), change the number of rooms or persons (decision block 510), select a link (decision block 512), select a room type (decision block 514), enter reservation data (decision block 516) or make the reservation (decision block 518, if all the required data has been entered). The process will loop until one of these options is selected or the user exits the system. If the user selects a month, as determined in decision block 506, the display is updated to show the selected month in block 520. One or more additional months may also be displayed. Next, the process loops back to await the next parameter change. If the user changes the number of rooms or persons, as determined in decision block 510, and the limits are not exceeded, as determined in decision block 522, the values in the room and reservation sections are adjusted accordingly in block 526 and the process loops back to await the next parameter change. If, however, the limits are exceeded, as determined in decision block 522, an error message is displayed in block 524 and the process loops back to await the next parameter change. If the user selects a link, as determined in decision block 512, the user is transferred to the destination of the selected link in block 528. If the user enters the reservation data, as determined in decision block 530, and there are no data errors, as determined in decision block 530, the process loops back to await the next parameter change. If, however, there are data errors, as determined in decision block 530, an error message is displayed in block 532 and the process loops back to await the next parameter change.

If the user selects a day, as determined in decision block 508, and the selected day is already highlighted, as determined in decision block 534, and the selected day is equal to the checkin day, as determined in decision block 536, the checkout day is set to the current checkout day plus one in block 538, the selected day is unhighlighted in block 540, and the process loops back to await the next parameter change. If the selected day is not equal to the checkin day, as determined in decision block 536, and the selected day is equal to the checkout day, as determined in decision block 542, the checkout day is set to the current checkout day minus one in block 544, the selected day is unhighlighted in block 546, and the process loops back to await the next parameter change. If the selected day is not equal to the checkout day, as determined in decision block 542, and the selected day is closer to the checkin day, as determined in decision block 548, the selected day is set as the checkin day in block 550, the old checkin day to the selected day is unhighlighted in block 552, and the process loops back to await the next parameter change. If the selected day is not closer to the checkin day, as determined in decision block 548, the selected day is set as the checkout day in block 554, the old checkout day to the selected day is unhighlighted in block 556, and the process loops back to await the next parameter change.

If the selected day is not highlighted, as determined in decision block 534, and there is a range error, as determined in decision block 560, an error message is displayed in block 560 and the process loops back to await the next parameter change. If, however, there is not a range error, as determined in decision block 558, and the selected day is the first day to be selected, as determined in decision block 562, the selected day is set as the checkin day in block 564, the selected day is highlighted in block 566 and the process loops back to await the next parameter change. If, however, the selected day is not the first day, as determined in decision block 562, and the selected day is before the first day, as determined in decision block 568, the selected day is set to the checkin day and the first day is set to the checkout day in block 570. If the selected day is not before the first day, as determined in decision block 568, the selected day is set to the checkout day in block 572. Following blocks 570 and 572, the days between the checkin day and the checkout day are highlighted in block 574 and the values in the room and reservation sections are adjusted accordingly, which may mean that room types that are unavailable between the checkin day and the checkout day are blocked out as unavailable, in block 576. If a room type has been selected, as determined in decision block 578, the daily room rates are inserted in the calendar in block 580. Thereafter and if a room type has not been selected, as determined in decision block 578, the process loops back to await the next parameter change.

If the user selects a room type, as determined in decision block 514, the room type is highlighted, a picture of the room is shown and available dates for that room type are displayed in the calendar in block 582. If checkin and checkout dates have been selected, as determined in decision block 584, the daily room rates are inserted in the calendar and the prices are adjusted accordingly in block 586. Thereafter and if checkin and checkout dates have not been selected, as determined in decision block 584, the process loops back to await the next parameter change.

If the user selects the make reservation button, as determined in decision block 518, and there are data errors, as determined in decision block 590, an error message is displayed in block 590 and the process loops back to await the next parameter change. If, however, there are no errors, as determined in decision block 590, the reservation is made in block 592, a confirmation is sent to the user in block 594 and the process ends in block 596.

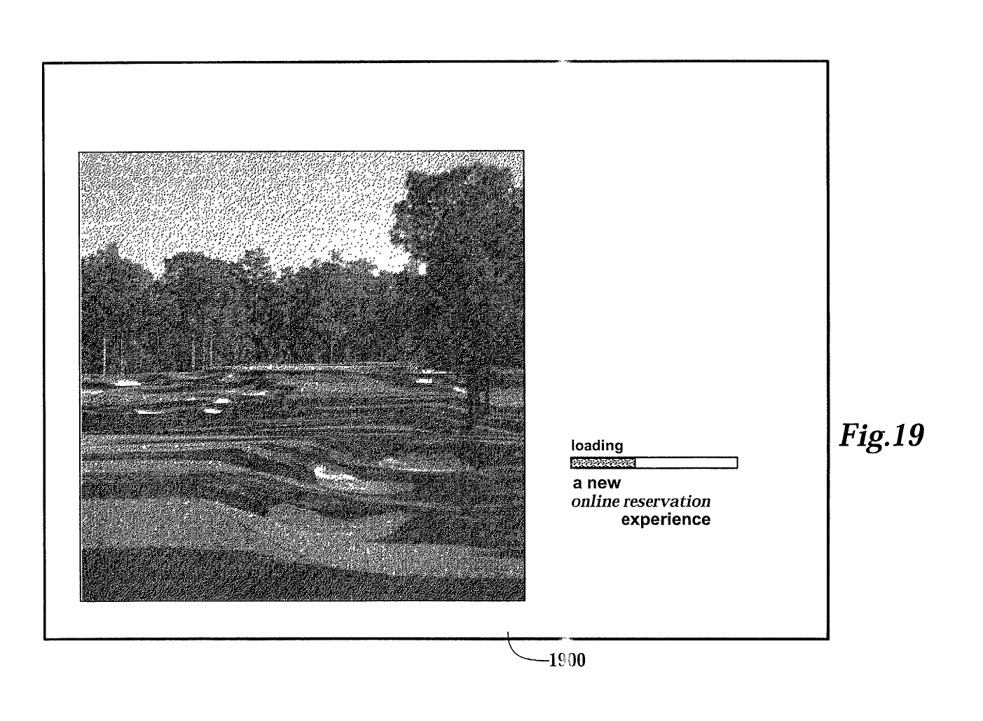

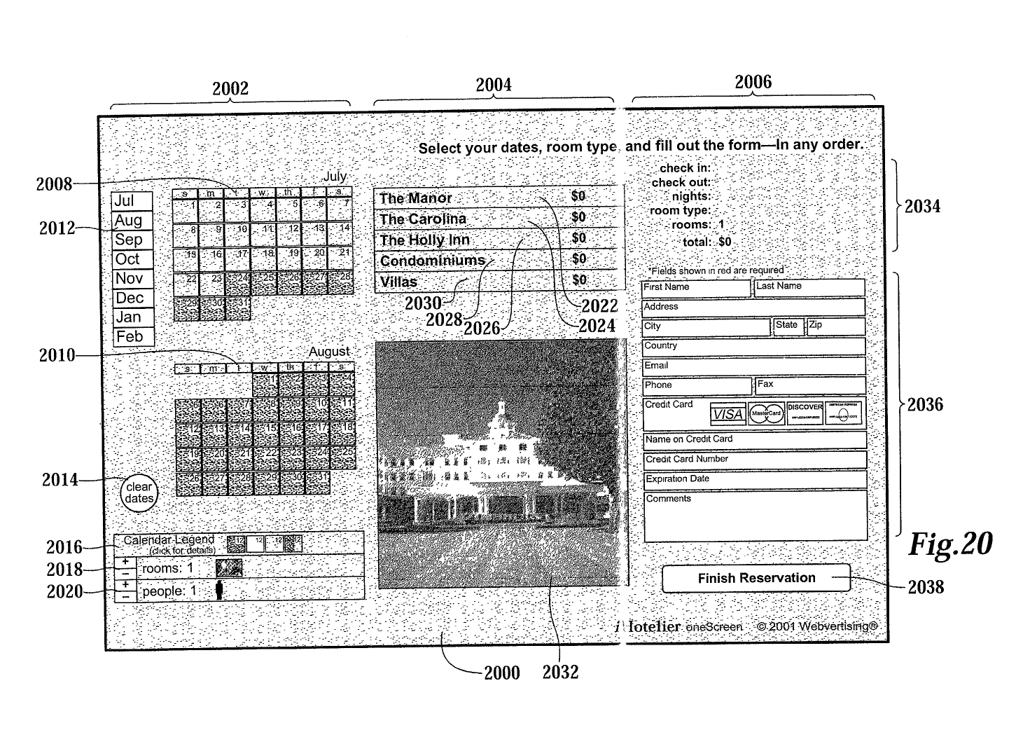

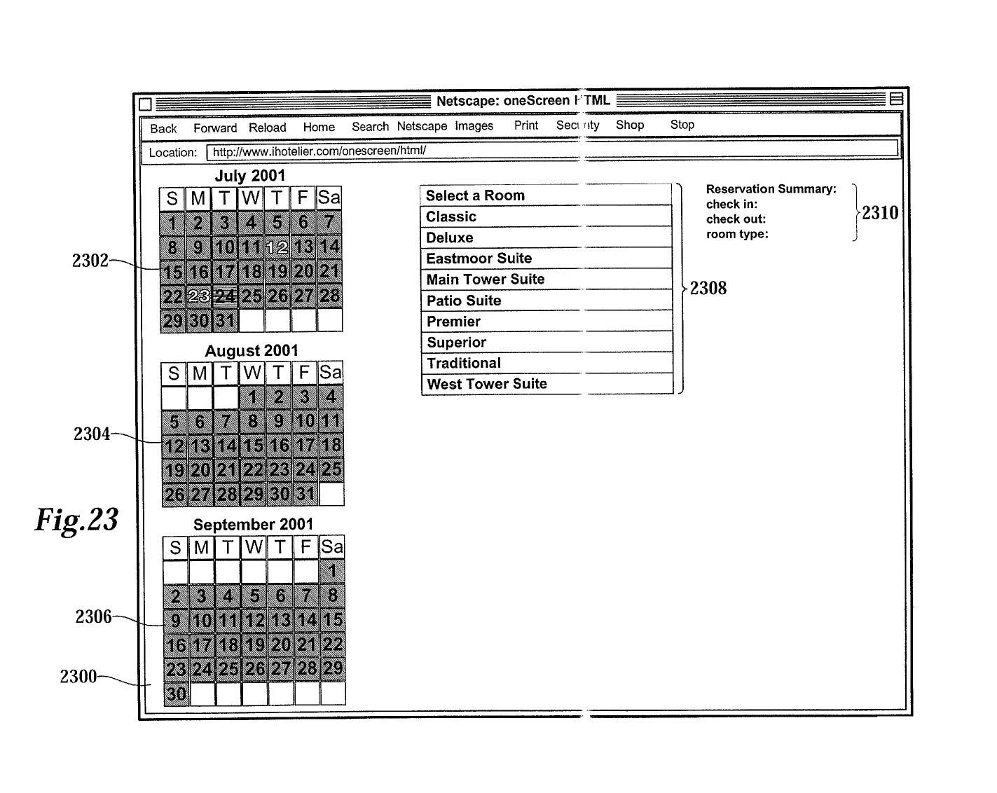

FIGS. 6 through 26 are screen shots of three examples of an iHotelier oneScreen in various stages of use for several variations in its design, including the original version used for the Broadmoor Hotel (FIGS. 6 through 18), a second design used for a demonstration for Pinehurst (FIGS. 19 through 22), and a HTML version (FIGS. 23 through 26). These screenshots (FIGS. 6 through 26) show the oneScreen interface as a user might progress through the reservation process. The screenshots attempt to illustrate some examples of the possible situations that might arise during the course of a reservation.

FIG. 6 is a screen shot of the oneScreen interface 600 prior to any user inputs in accordance with one embodiment of the present invention. OneScreen interface 600 includes a calendar section 602, inventory information section 604 and reservation information section 606. The calendar section 602 includes a first calendar 608 of the current month, a second calendar 610 of the next month, a month section portion 612, a clear dates button 614, a calendar legend 616, a room quantity selection portion 618 and a people quantity selection portion 620. As shown, the current date is July 24, so that date and any date shown thereafter is highlighted or shaded to indicate that those dates can be selected. The inventory information section 604 includes the various room types for the hotel (Traditional Room 622, Classic Room 624, Deluxe Room 626, Premier Room 628, Main Tower Suite 630 and Eastmoor Suite 632) and a display area for further information 634. The reservation information section 606 includes a summary portion 636, a number of reservation entry data fields 638 and a finish reservation button 640. The summary portion 636 includes the check in date 642, check out date 644, number of nights 646, room type 648, number of rooms 650 and total price 652. The reservation data entry fields 638 includes first name 654, last name 656, address 658, city 660, state 662, zip code 664, country 666, email address 668, phone number 670, fax number 672, credit card selection 674, name on credit card 676, credit card number 678, expiration date 680 and comments 682.

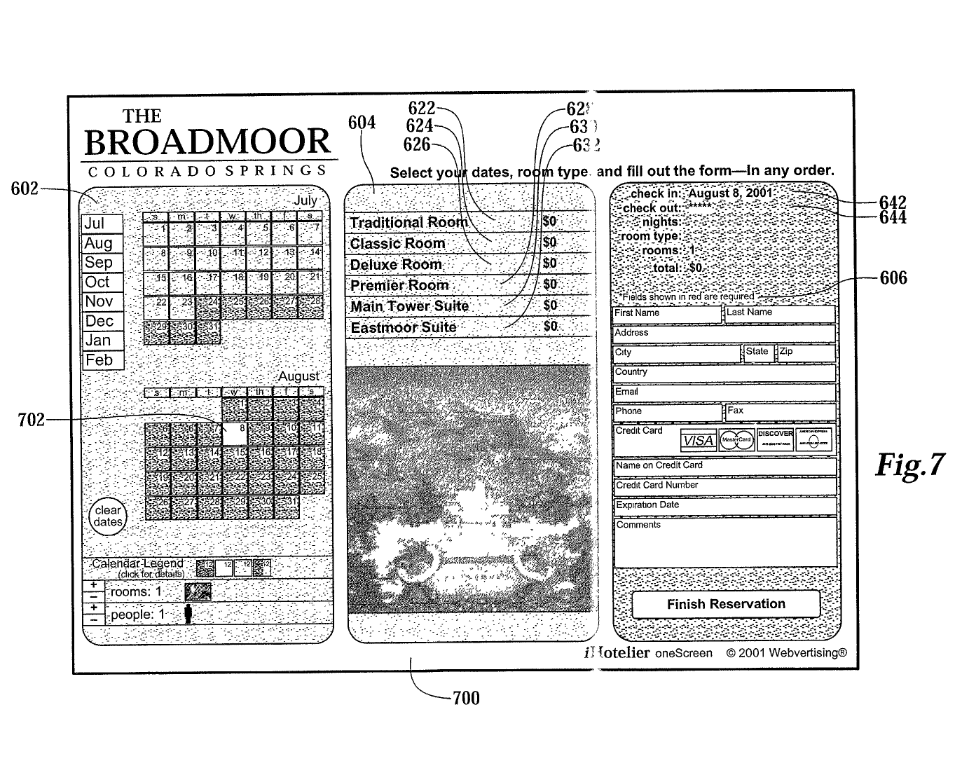

FIG. 7 is a screen shot of the oneScreen interface 700 with one date only selected 702 and no room type selected in accordance with one embodiment of the present invention. The user uses his or her mouse to select a day by clicking on that day. Alternatively, the keyboard could be used. As a result the selected date 702 is highlighted within the second calendar 610 within the calendar section 602. Since this is the first day to be selected, the selected date 702 is assumed for the moment to be the checkin day, which is indicated in the check in day 642 within the reservation information section 606. Asterisks are shown in the check out day 644 since such a day has not been selected.

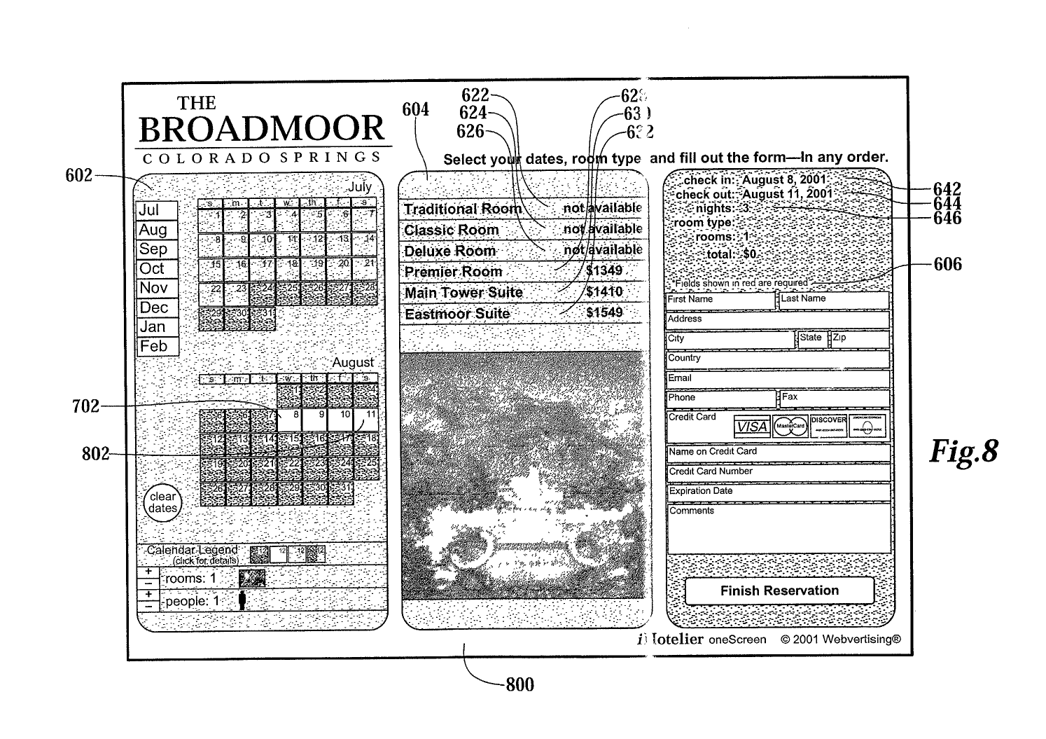

FIG. 8 is a screen shot of the oneScreen interface 800 with multiple dates selected and no room type selected in accordance with one embodiment of the present invention. The user uses his or her mouse to select a second day by clicking on that day. As a result the selected date 802 is highlighted within the second calendar 610 within the calendar section 602. Since this is the second day to be selected, the dates between the selected dates 702 and 802 are highlighted. In addition, selected date 802 is determined to be the checkout day because it is after the checkin date. The checkout day is indicated in check out day 644 within the reservation information section 606. The number of nights 646 selected is also indicated. The various room types that are available for the hotel during the selected dates are highlighted and the total price for that room type (Premier Room 628, Main Tower Suite 630 and Eastmoor Suite 632) are indicated in the inventory information section 604. Those room types that are not available during the selected dates are not highlighted and a note is displayed indicating that they are not available (Traditional Room 622, Classic Room 624 and Deluxe Room 626). All of this is the result of one mouse click by the user.

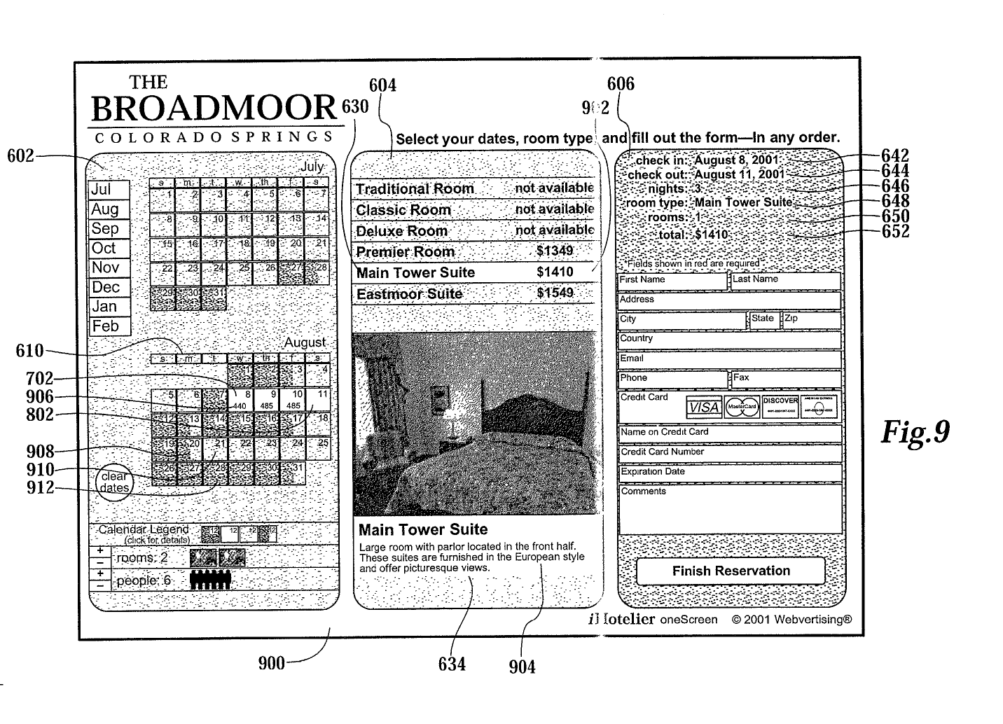

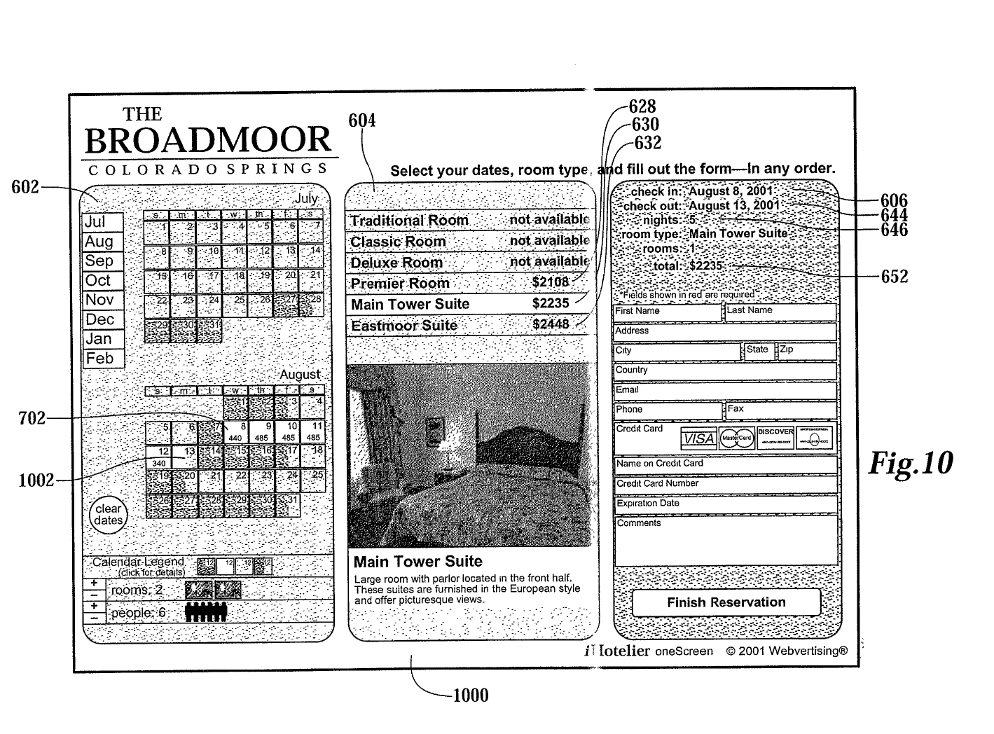

FIG. 9 is a screen shot of the oneScreen interface 900 with multiple dates selected, room type selected and selected dates showing daily rates in accordance with one embodiment of the present invention. The user uses his or her mouse to select a room type by clicking on that room type. As a result the selected room type 902 (main tower suite 630) is highlighted within the inventory information section 604. In addition, a picture and description 904 of the selected room type 902 is shown in the display area for further information 634. The room type 648 and total price 652 is also shown within the reservation information section 606. The number of nights 646 selected in also indicated. The daily price 906 for the selected room type 902 is displayed within the second calendar 610. Moreover, the dates that the selected room type 902 are available during the two or more months shown are distinguished from those dates that are not available (compare dates available 912 with dates not available 910). A date that is only half highlighted, such as 908, indicates that the selected room type 902 is available for the night before, but not the night after. All of this is the result of one mouse click by the user.

FIG. 10 is a screen shot of the oneScreen interface 1000 as in FIG. 9, but more dates added to include a check-out-only date in accordance with one embodiment of the present invention. The user uses his or her mouse to select a day, which changes the check out day, by clicking on that day. As a result the selected date 1002 is highlighted within the second calendar 610 within the calendar section 602. Since the selected day 1002 is after the checkin day 702, the selected day 1002 becomes the new checkout day and the dates between the selected dates 702 and 1002 are highlighted. Daily price information is also extended to the newly selected days. The new checkout day is indicated in check out day 644 within the reservation information section 606. The revised number of nights 646 selected and the total price 652 are also indicated. In addition, the various room types that are available for the hotel during the selected dates are highlighted and the total price for that room type (Premier Room 628, Main Tower Suite 630 and Eastmoor Suite 632) are indicated in the inventory information section 604. Those room types that are not available during the selected dates are not highlighted and a note is displayed indicating that they are not available (Traditional Room 622, Classic Room 624 and Deluxe Room 626). In this particular case, only the pricing information was revised (see 628, 630 and 632). All of this is the result of one mouse click by the user.

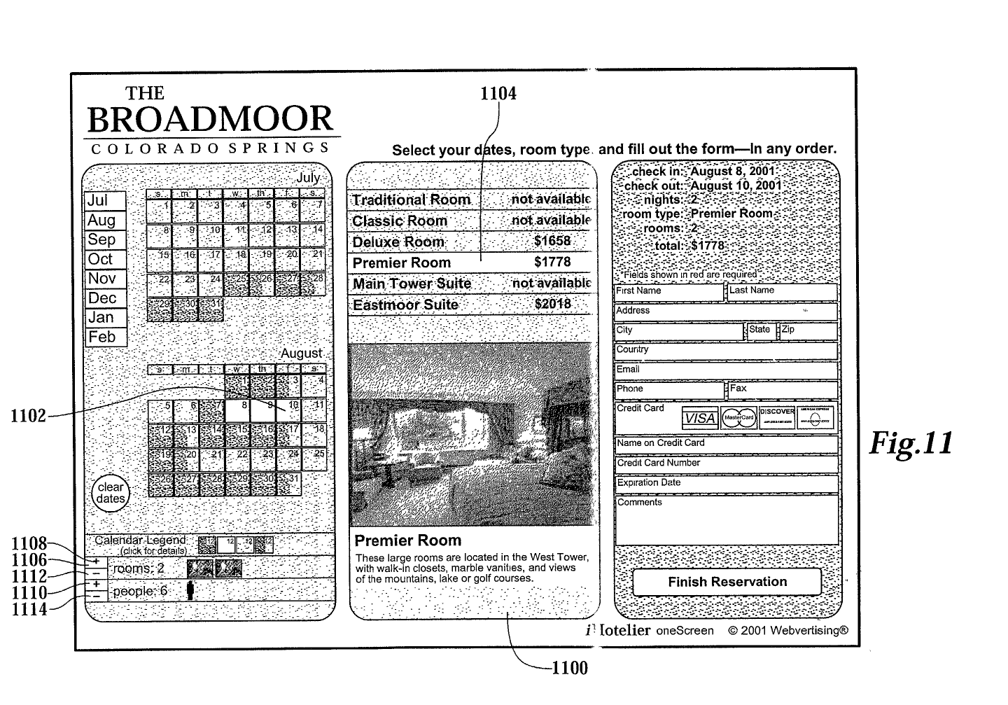

FIG. 11 is a screen shot of the oneScreen interface 1100 wherein another room type and different dates are selected, and an extra room is added in accordance with one embodiment of the present invention. In this case, all the information displayed in interface 110 could be accomplished in three mouse clicks: a new checkout day 1102, a new room type 1104 and an added room 1106. The number or rooms 618 or persons 620 can be changed by clicking on the plus sign buttons 1108 and 1110 or the minus sign buttons 1112 and 1114. Other methods could be used.

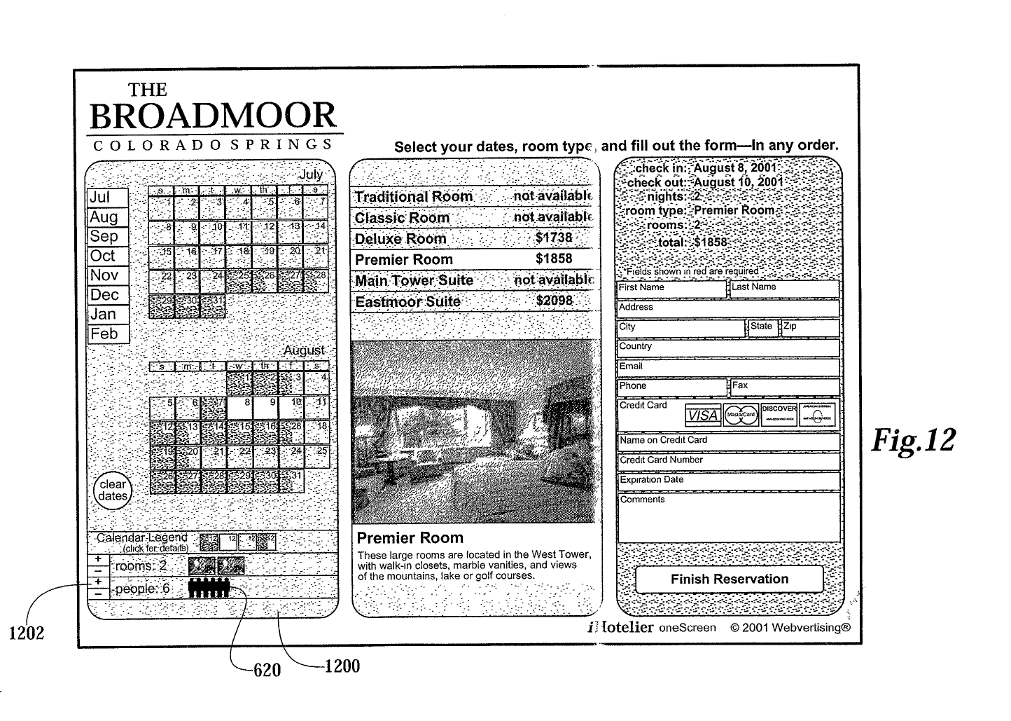

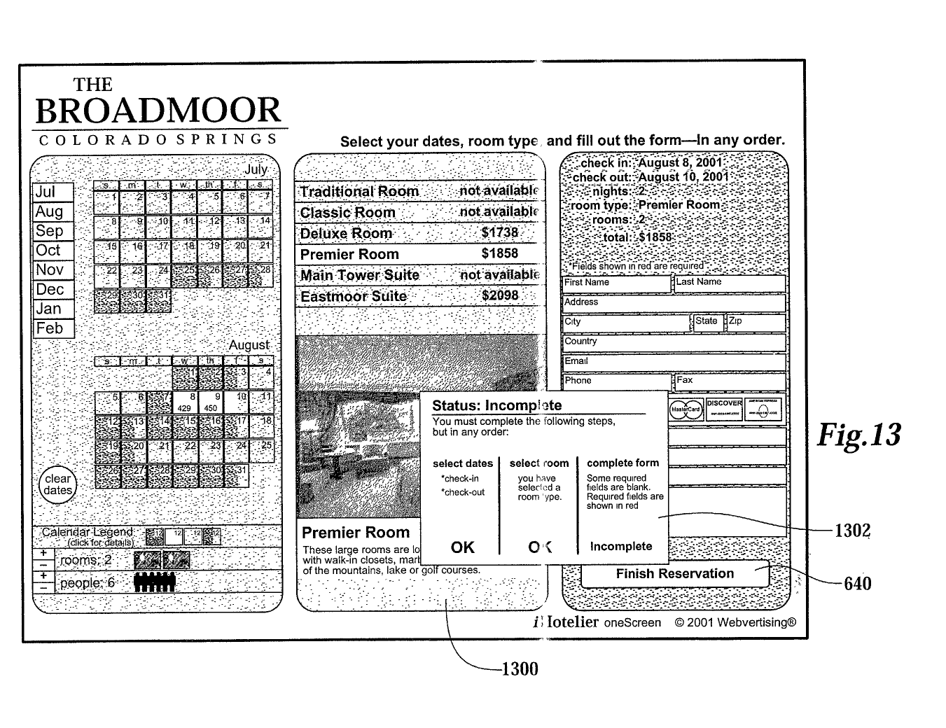

FIG. 12 is a screen shot of the oneScreen interface 1200 as in FIG. 11, but extra rooms and people are added in accordance with one embodiment of the present invention. In this case, the user increases the number of people 620 by clicking on plus sign buttons 1202. All of the information displayed is adjusted automatically.

FIG. 13 is a screen shot of the oneScreen interface 1300 showing a pop-up error/status message 1302 that prevents clicking on the Finish Reservation button 640 until all required tasks are complete in accordance with one embodiment of the present invention.

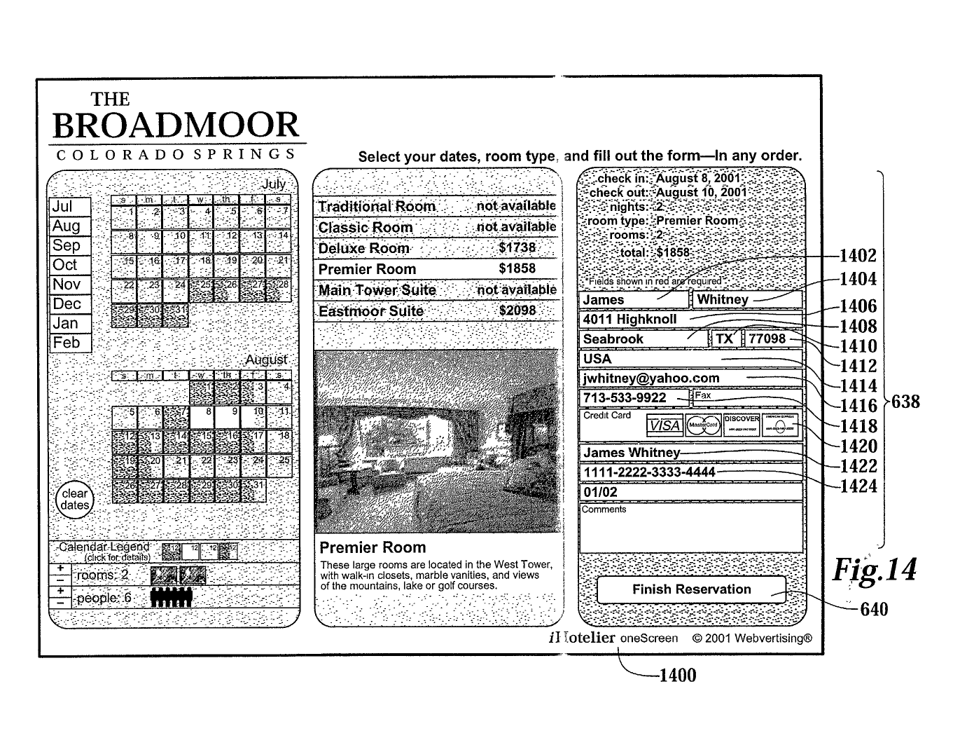

FIG. 14 is a screen shot of the oneScreen interface 1400 wherein the reservation data entry fields 638 are almost filled out, Finish Reservation button 640 not yet clickable in accordance with one embodiment of the present invention. The completed reservation data entry fields 638 includes first name 1402, last name 1404, address 1406, city 1408, state 1410, zip code 1412, country 1414, email address 1416, phone number 1418, credit card selection 1420, name on credit card 1422 and credit card number 1424. Clicking on the appropriate credit card icon makes the credit card selection 1420.

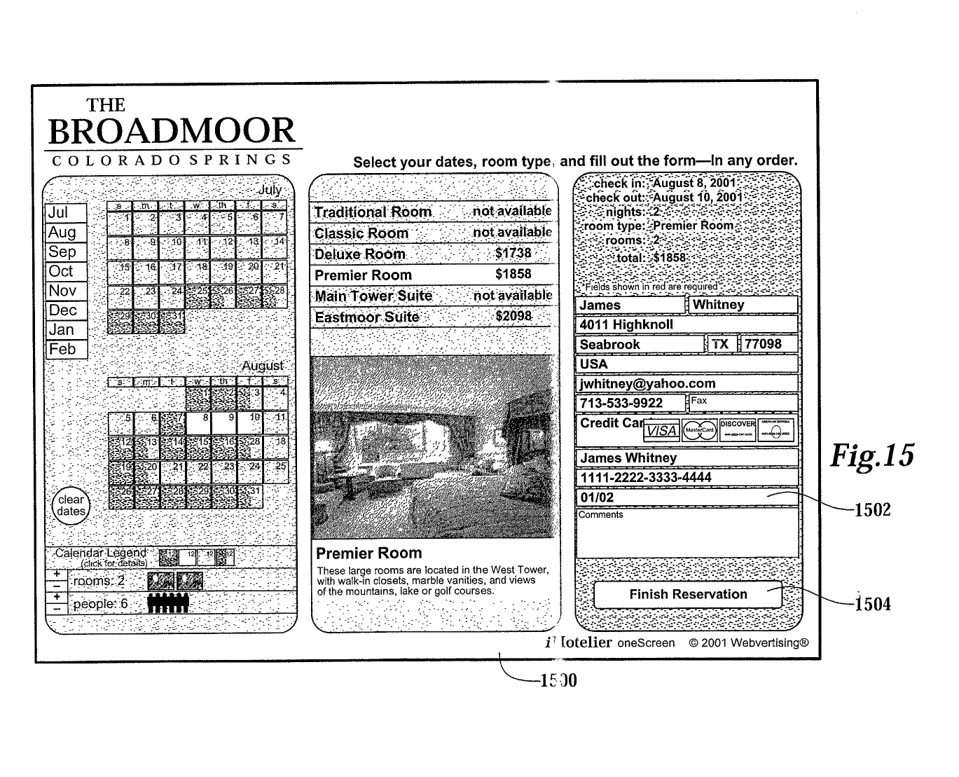

FIG. 15 is a screen shot of the oneScreen interface 1500 wherein all the remaining information (credit card expiration date 1502) has been entered into the form and the Finish Reservation button 1504 turns on in accordance with one embodiment of the present invention.

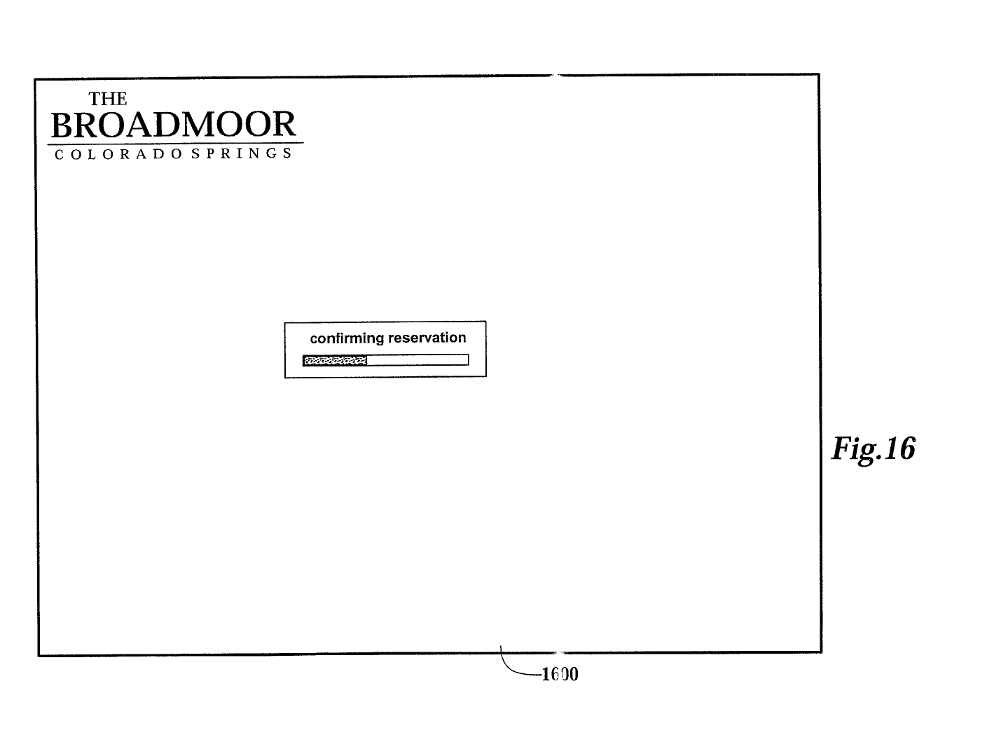

FIG. 16 is a screen shot of the oneScreen interface 1600 wherein the reservation and personal information are being sent, and the user is waiting for confirmation from the server in accordance with one embodiment of the present invention.

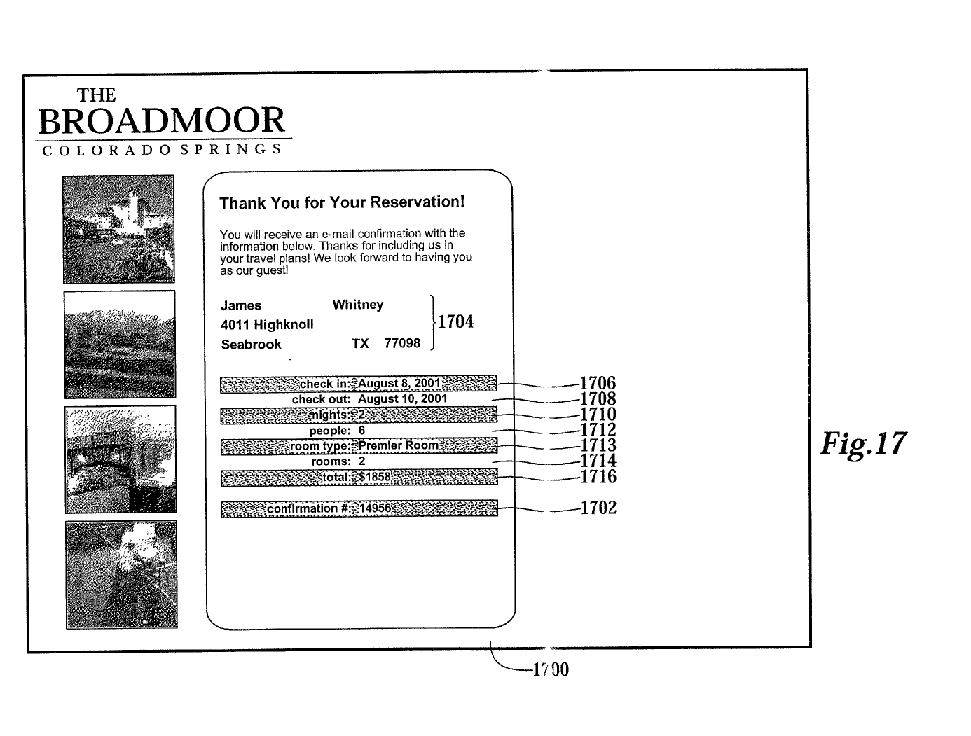

FIG. 17 is a screen shot of the oneScreen interface 1700 showing the confirmation screen after the reservation has been inserted into the database and retrieved a confirmation number 1702 in accordance with one embodiment of the present invention. The interface 1700 displays customer billing information 1704, check in date 1706, check out date 1708, the number of nights 1710, the number of people 1712, the number of rooms 1714, the total price 1716 and the confirmation number 1702. Other information could be displayed. In addition, the confirmation can be sent to the user via fax, e-mail or regular mail.

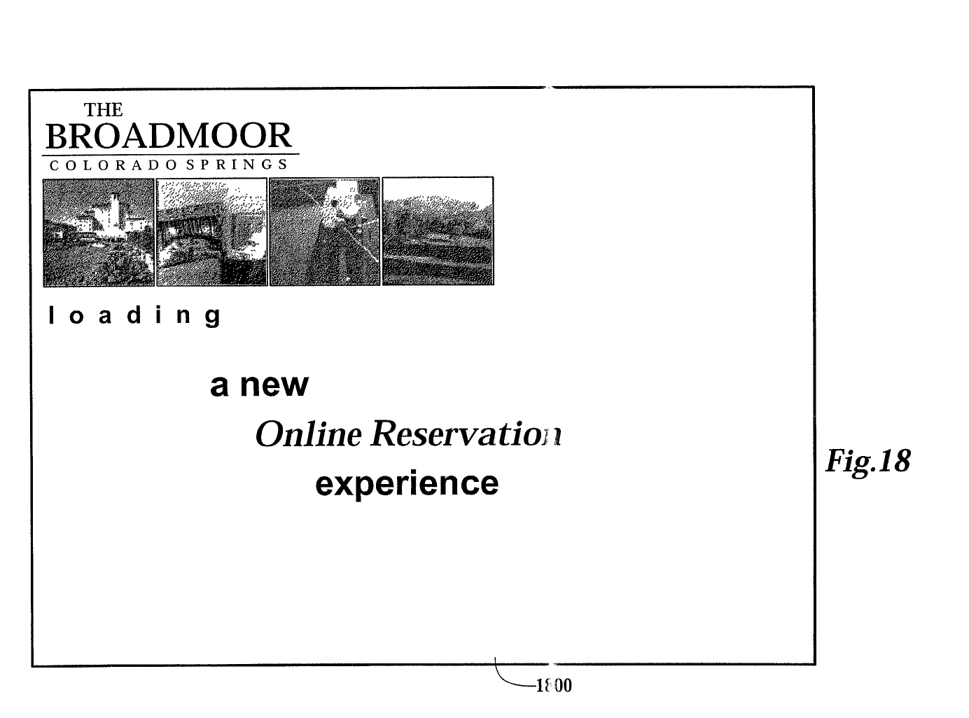

FIG. 18 is a screen shot of the oneScreen interface 1800 showing the Broadmoor loading sequence in accordance with one embodiment of the present invention.

FIG. 19 is a screen shot of the oneScreen interface 1900 showing the Pinehurst version loading sequence in accordance with one embodiment of the present invention.

FIG. 20 is a screen shot of the oneScreen interface 2000 of the Pinehurst version main operating space with no user inputs in accordance with one embodiment of the present invention. OneScreen interface 2000 includes a calendar section 2002, inventory information section 2004 and reservation information section 2006. The calendar section 2002 includes a first calendar 2008 of the current month, a second calendar 2010 of the next month, a month section portion 2012, a clear dates button 2014, a calendar legend 2016, a room quantity selection portion 2018 and a people quantity selection portion 2020. As shown, the current date is July 24, so that date and any date shown thereafter is highlighted or shaded to indicate that those dates can be selected. The inventory information section 2004 includes the various room types for the hotel (The Manor 2022, The Carolina 2024, the Holly Inn 2026, Condominiums 2028 and Villas 2030) and a display area for further information 2032. The reservation information section 2006 includes a summary portion 2034, a number of reservation entry data fields 2036 and a finish reservation button 2038. The summary portion 2034 and the reservation data entry fields 2038 include the information displayed and described in reference to FIG. 6.

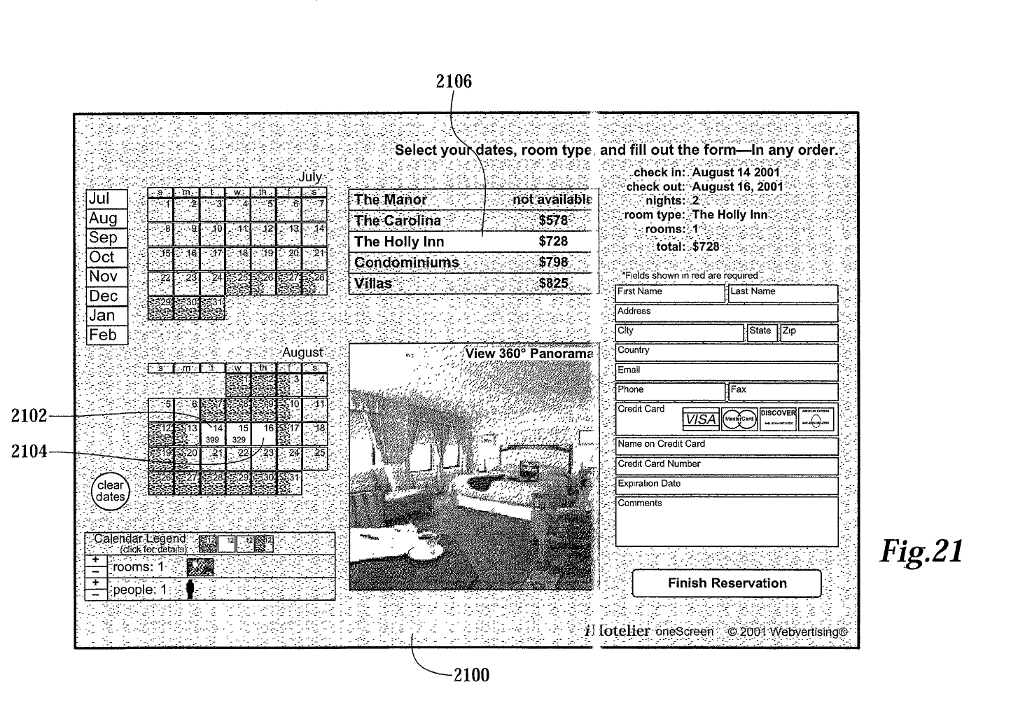

FIG. 21 is a screen shot of the oneScreen interface 2100 Pinehurst version with dates and room type selected in accordance with one embodiment of the present invention. In this exampled, a checkin day 2102, check out day 2104 and a room type 2106. All of the data within the display is modified accordingly and as described in reference to FIGS. 7, 8 and 9.

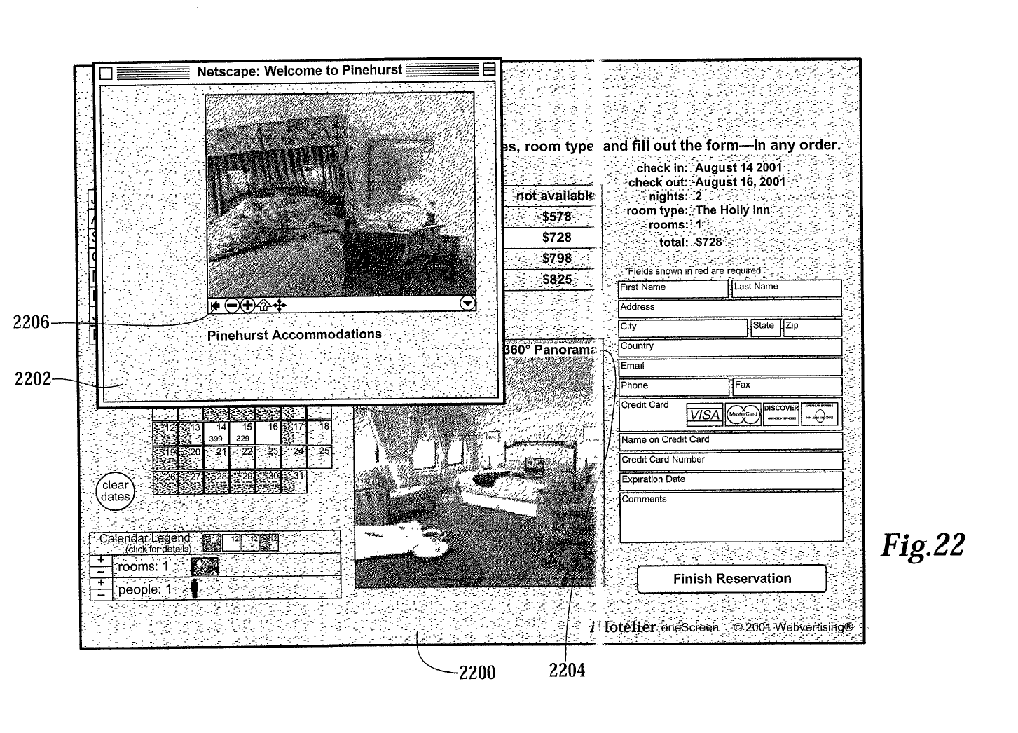

FIG. 22 is a screen shot of the oneScreen interface 2200 Pinehurst version, showing pop-up Virtual Tour window 2202 in accordance with one embodiment of the present invention. Clicking on command 2204 activates the pop-up Virtual Tour window 2202, which includes various view control commands 2206.

FIG. 23 is a screen shot of the oneScreen interface 2300 HTML version before any user inputs in accordance with one embodiment of the present invention. This particular example displays three months of data 2302, 2304 and 2306, room type information 2308 and reservation summary information 2310.

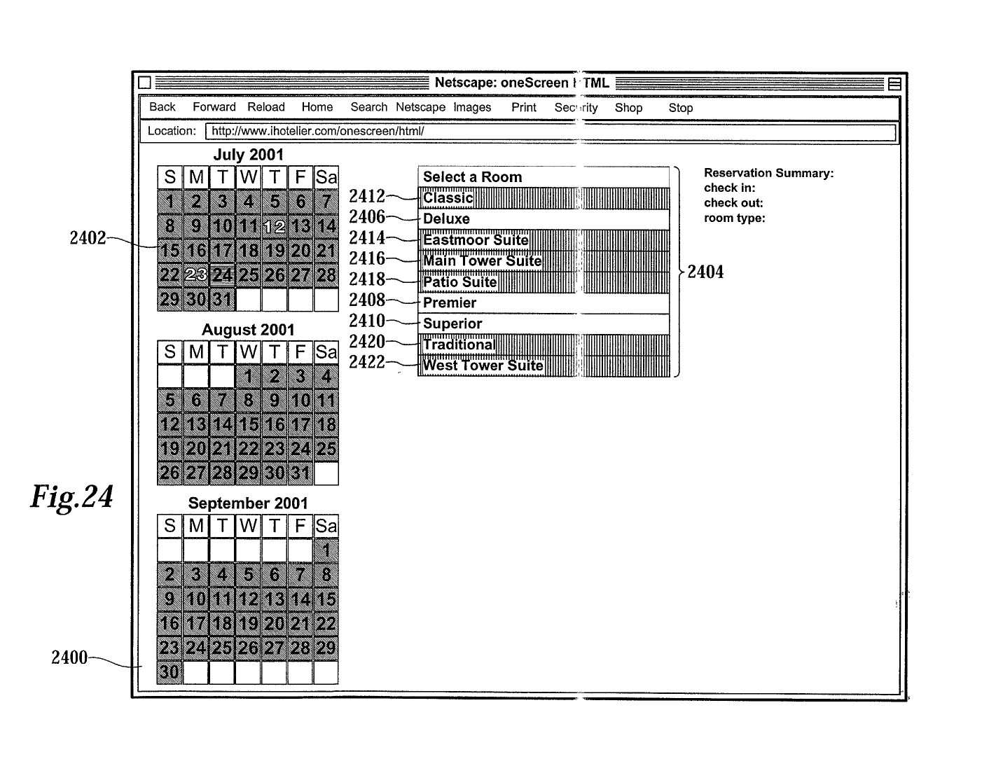

FIG. 24 is a screen shot of the oneScreen interface 2400 wherein clicking a calendar date 2402 shows availability using various highlights or colors on the room type frame 2404 in accordance with one embodiment of the present invention. Room types 2406 (Deluxe), 2408 (Premier) and 2410 (Superior) are available; whereas, room types 2412 (Classic), 2414 (Eastmoor Suite), 2416 (Main Tower Suite), 2418 (Patio Suite), 2420 (Traditional) and 2422 (West Tower Suite) are not available.

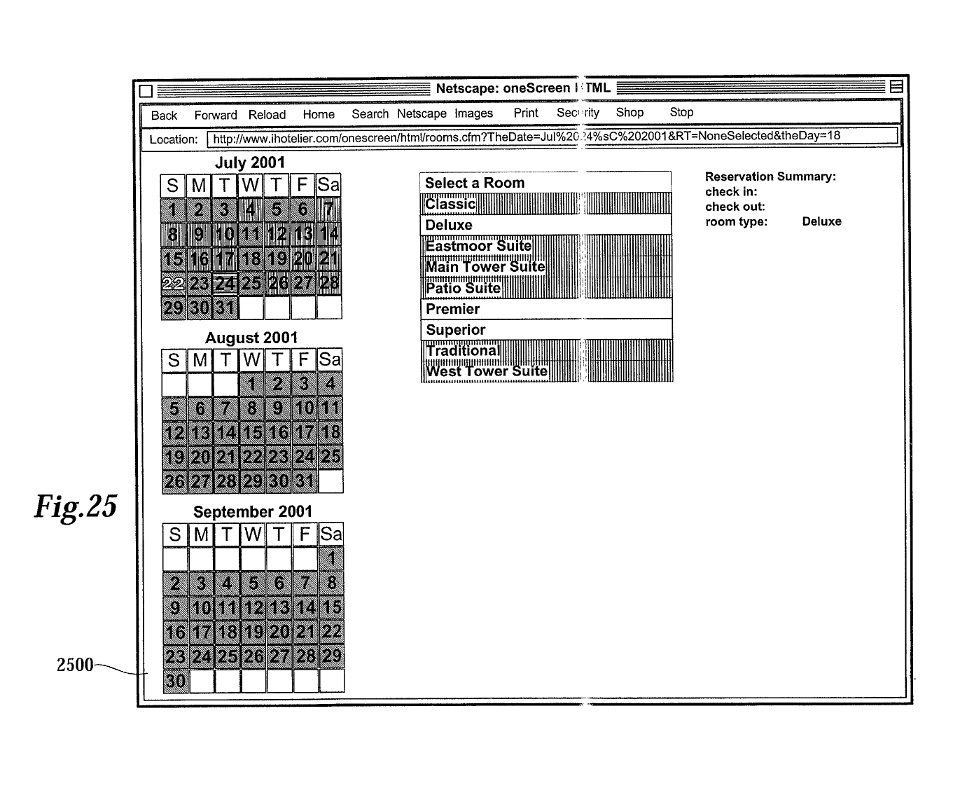

FIG. 25 is a screen shot of the oneScreen interface 2500 wherein room type availability is displayed, selecting a room type shows availability on calendar in accordance with one embodiment of the present invention.

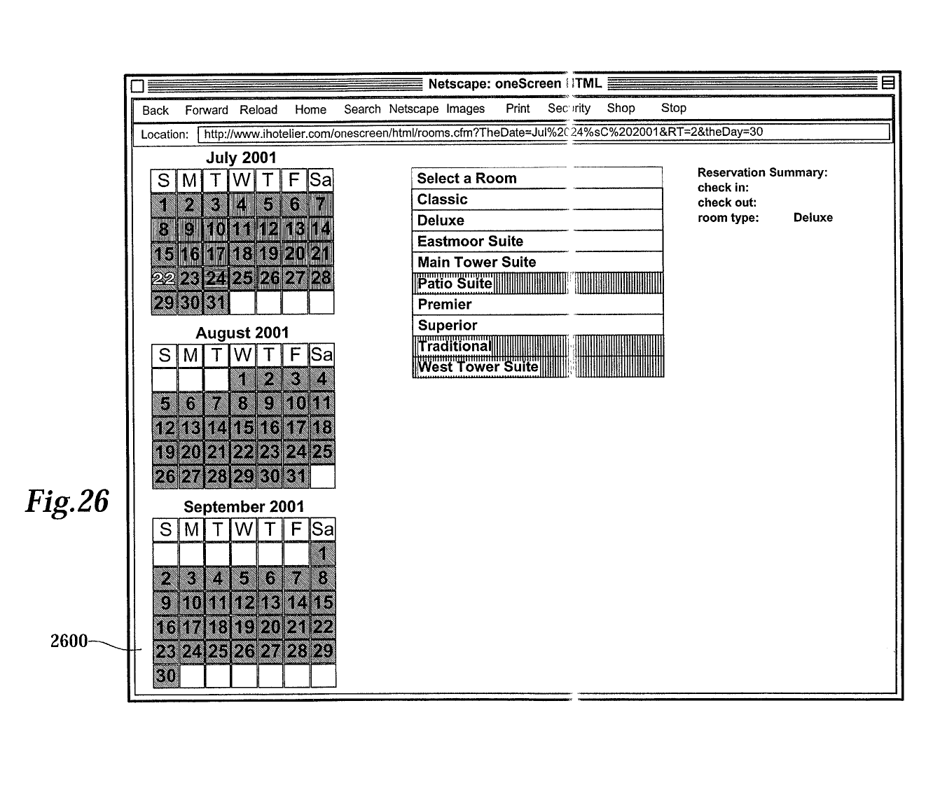

FIG. 26 is a screen shot of the oneScreen interface 2600 HTML version showing another room type selected, room type availability and calendar availability in accordance with one embodiment of the present invention.

The embodiments and examples set forth herein are presented to best explain the present invention and its practical application and to thereby enable those skilled in the art to make and utilize the invention. However, those skilled in the art will recognize that the foregoing description and examples have been presented for the purpose of illustration and example only. The description as set forth is not intended to be exhaustive or to limit the invention to the precise form disclosed. Many modifications and variations are possible in light of the above teaching without departing from the spirit and scope of the following claims.

What is claimed is:

1. A method of formatting inventory data comprising the steps of:
receiving a request for inventory data about an inventory at a location;
retrieving the inventory data;
formatting the inventory data to be displayed in a calendar section, an inventory information section and a reservation information section within a single screen;
sending a response containing the formatted inventory data;
receiving a parameter further defining the request for inventory data; and
determining whether the received parameter changes the formatted inventory data, and reformatting the inventory data changed by the received parameter within the single screen and sending the reformatted inventory data whenever the received parameter changes the formatted inventory data.

2. The method as recited in claim 1, further comprising the step of determining whether the received parameter requests that a reservation be made, and making the reservation and sending a reservation confirmation whenever the received parameter requests that a reservation be made.

3. The method as recited in claim 1, wherein the reformatted inventory data comprises a map of the location within the inventory information section.

4. The method as recited in claim 1, wherein the parameter indicates a selected inventory type and the reformatted inventory data comprises an image of the selected inventory type within the inventory information section.

5. The method as recited in claim 1, wherein the parameter indicates a selected inventory type and the reformatted inventory data comprises a visual indication of when the selected inventory type is available within the calendar section.

6. The method as recited in claim 1, wherein the inventory comprises two or more rooms and the location comprises a hotel.

7. The method as recited in claim 1, wherein the inventory comprises two or more vehicles and the location comprises a rental agency.

8. The method as recited in claim 1, wherein the inventory comprises two or more cabins and the location comprises a cruise ship.

9. The method as recited in claim 1, wherein the inventory comprises two or more seats and the location comprises an airplane.

10. The method as recited in claim 1, wherein the inventory comprises two or more seats and the location comprises an entertainment venue.

11. The method as recited in claim 1, wherein the calendar section comprises two or more calendars.

12. The method as recited in claim 11, wherein the two or more calendars comprise:
a first calendar for a current month;
a second calendar for a next month; and
a month selection portion.

13. The method as recited in claim 1, wherein the inventory information section comprises:
one or more types of the inventory; and
an indication of availability for each type of the inventory.

14. The method as recited in claim 1, wherein the reservation information section comprises:
one or more customer data fields;
one or more payment data fields; and
an order summary.

15. The method as recited in claim 1, wherein the single screen further comprises one or more links to other information.

16. The method as recited in claim 1, wherein the single screen further comprises one or more navigation and control commands.

17. A computer program embodied on a computer readable medium for formatting inventory data comprising:
a code segment for receiving a request for inventory data about an inventory at a location;
a code segment for retrieving the inventory data;
a code segment for formatting the inventory data to be displayed in a calendar section, an inventory information section and a reservation information section within a single screen;
a code segment for sending a response containing the formatted inventory data;
a code segment for receiving a parameter further defining the request for inventory data; and
a code segment for determining whether the received parameter changes the formatted inventory data, and reformatting the inventory data changed by the received parameter within the single screen and sending the reformatted inventory data whenever the received parameter changes the formatted inventory data.

18. The computer program as recited in claim 17, further comprising a code segment for determining whether the received parameter requests that a reservation be made, and making the reservation and sending a reservation confirmation whenever the received parameter requests that a reservation be made.

19. The computer program as recited in claim 17, wherein the reformatted inventory data comprises a map of the location within the inventory information section.

20. The computer program as recited in claim 17, wherein the parameter indicates a selected inventory type and the reformatted inventory data comprises an image of the selected inventory type within the inventory information section.

21. The computer program as recited in claim 17, wherein the parameter indicates a selected inventory type and the reformatted inventory data comprises a visual indication of when the selected inventory type is available within the calendar section.

22. The computer program as recited in claim 17, wherein the inventory comprises two or more rooms and the location comprises a hotel.

23. The computer program as recited in claim 17, wherein the inventory comprises two or more vehicles and the location comprises a rental agency.

24. The computer program as recited in claim 17, wherein the inventory comprises two or more cabins and the location comprises a cruise ship.

25. The computer program as recited in claim 17, wherein the inventory comprises two or more seats and the location comprises an airplane.

26. The computer program as recited in claim 17, wherein the inventory comprises two or more seats and the location comprises an entertainment venue.

27. The computer program as recited in claim 17, wherein the calendar section comprises two or more calendars.

28. The computer program as recited in claim 27, wherein the two or more calendars comprise:
a first calendar for a current month;
a second calendar for a next month; and
a month selection portion.

29. The computer program as recited in claim 17, wherein the inventory information section comprises:
one or more types of the inventory; and
an indication of availability for each type of the inventory.

30. The computer program as recited in claim 17, wherein the reservation information section comprises:
one or more customer data fields;
one or more payment data fields; and
an order summary.

31. The computer program as recited in claim 17, wherein the single screen further comprises one or more links to other information.

32. The computer program as recited in claim 17, wherein the single screen further comprises one or more navigation and control commands.

33. A system for formatting inventory data:
a database;
a communications interface; and
a computer communicably coupled to the database and the communications interface, wherein the computer receives a request for inventory data about an inventory at a location from the communications interface, retrieves the inventory data from the database, formats the inventory data to be displayed in a calendar section, an inventory information section and a reservation information section within a single screen, sends a response containing the formatted inventory data to the communications interface, receives a parameter further defining the request for inventory data from the communications interface, and determines whether the received parameter changes the formatted inventory data, and reformats the inventory data changed by the received parameter within the single screen and sends the reformatted inventory data to the communications interface whenever the received parameter changes the formatted inventory data.

34. The system as recited in claim 33, wherein the computer further determines whether the received parameter requests that a reservation be made, and makes the reservation and sends a reservation confirmation whenever the received parameter requests that a reservation be made.

35. The system as recited in claim 33, wherein the reformatted inventory data comprises a map of the location within the inventory information section.

36. The system as recited in claim 33, wherein the parameter indicates a selected inventory type and the reformatted inventory data comprises an image of the selected inventory type within the inventory information section.

37. The system as recited in claim 33, wherein the parameter indicates a selected inventory type and the reformatted inventory data comprises a visual indication of when the selected inventory type is available within the calendar section.

38. The system as recited in claim 33, wherein the inventory comprises two or more rooms and the location comprises a hotel.

39. The system as recited in claim 33, wherein the inventory comprises two or more vehicles and the location comprises a rental agency.

40. The system as recited in claim 33, wherein the inventory comprises two or more cabins and the location comprises a cruise ship.

41. The system as recited in claim 33, wherein the inventory comprises two or more seats and the location comprises an airplane.

42. The system as recited in claim 33, wherein the inventory comprises two or more seats and the location comprises an entertainment venue.

43. The system as recited in claim 33, wherein the calendar section comprises two or more calendars.

44. The system as recited in claim 33, wherein the two or more calendars comprise:
a first calendar for a current month;
a second calendar for a next month; and
a month selection portion.

45. The system as recited in claim 33, wherein the inventory information section comprises:
one or more types of the inventory; and
an indication of availability for each type of the inventory.

46. The system as recited in claim 33, wherein the reservation information section comprises:
one or more customer data fields;
one or more payment data fields; and
an order summary.

47. The system as recited in claim 33, wherein the single screen further comprises one or more links to other information.

48. The system as recited in claim 33, wherein the single screen further comprises one or more navigation and control commands.
